(19) United States
(12) Patent Application Publication
(10) Pub. No.: US 2012/0159801 A1
(43) Pub. Date: Jun. 28, 2012

(54) DEHYDRATING DEVICE

(76) Inventors: Chin-Feng Chang, Taichung (TW); Hong-Hsin Lai, Taichung (TW)

(21) Appl. No.: 12/979,378

(22) Filed: Dec. 28, 2010

(51) Int. Cl. F26B 25/06

(52) U.S. Cl. 34/218

(57) ABSTRACT

The present invention discloses a dehydrating device comprising air diverging duct, linkage tube, dryer, air converging duct, water converging container and dehydrating room. The air blown from the blower sequentially passes through the air diverging duct, the linkage tube, the wavy first flow path and the U-shape second flow path of the dryer to be dehydrated. After being dried by the dryer, the air flows out of the sixth outlet of the air converging duct for further application. The device is designed to accomplish objectives such as improving the efficiency of dehydrating air, saving energy, being expandable and so on.

### FIELD OF THE INVENTION

The present invention relates to a dehydrating device, particularly to a device comprising at least one dryer which has a wavy first flow path and a U-shape second flow path to improve the efficiency of air dehydration.

### BACKGROUND OF THE INVENTION

According to the prior arts of dehydrating devices, they usually comprise an exsiccating room and a dehydrating room in a box. There is a plurality of ventholes defined between the exsiccating room and the dehydrating room. The exsiccating room has air inlets and the dehydrating room has air outlets. Air is forced to flow through the air inlets into the exsiccating room in order to exsiccate the air. After the exsiccation, the air flows into the dehydrating room and then is discharged from the air outlets. There is also a drying unit equipped in the dehydrating room in order to dehydrate the air and then to generate dry air.

There are certain disadvantages from the prior arts of the dehydrating devices:

1. When a great amount of air is blown into the exsiccating room by a blower connected with the air inlets, only one drying unit is equipped to process the air and, therefore, the result of dehydration is insufficient.

2. The drying unit applies evaporators to dehydrate the air, but the dried air is easily mixed with the vapor in the dehydrating room. Therefore, the dehydration process is not perfect enough.

3. The drying unit is equipped with evaporators and condensers, but they consume a lot of energy.

### SUMMARY OF THE INVENTION

The object of the present invention is to provide a dehydrating device which is able to improve the efficiency of air dehydration. In order to achieve the foregoing object, the dehydrating device comprises an air diverging duct, a linkage tube, a dryer, an air converging duct, a water converging container and a dehydrating room. The air blown from the blower sequentially passes through the air diverging duct, the linkage tube, the wavy first flow path and the U-shape second flow path of the dryer, and then flows out of the sixth outlet of the air converging duct for further application. Wherein, after the air passes through the first flow path, the moisture of the air is going to deposit on the separations, flow downwards to the bottom of the first chamber and then be drained out of the first chamber through the drainpipe. The air reached the U-shape second flow path has been dehydrated to certain level. When it flows out of the sixth outlet, the air is capable of being applied to dry other objects.

### BRIEF DESCRIPTION OF THE DRAWINGS

FIG. 1 is an exploded drawing of the dehydrating device in accordance with the present invention;

FIG. 2 is an exploded drawing of the dryer in accordance with the present invention;

FIG. 3 is an assembled drawing in part of the dryer in accordance with the present invention;

FIG. 4 is an assembled drawing in part of the dehydrating device in accordance with the present invention;

FIG. 5 is an exterior drawing of the dehydrating device in accordance with the present invention;

FIG. 6 is a front view of the dehydrating device in accordance with the present invention;

FIG. 7 is a cross sectional view taken along plane A-A in FIG. 6;

FIG. 8 is a cross sectional view of the dryer in accordance with the present invention;

FIG. 9 is an exploded drawing of the dryer of the second embodiment in accordance with the present invention;

FIG. 10 is an exploded drawing of the dryer of the third embodiment in accordance with the present invention; and

FIG. 11 is an assembled drawing in part of another embodiment in accordance with the present invention.

### DETAILED DESCRIPTION OF THE PREFERRED EMBODIMENT

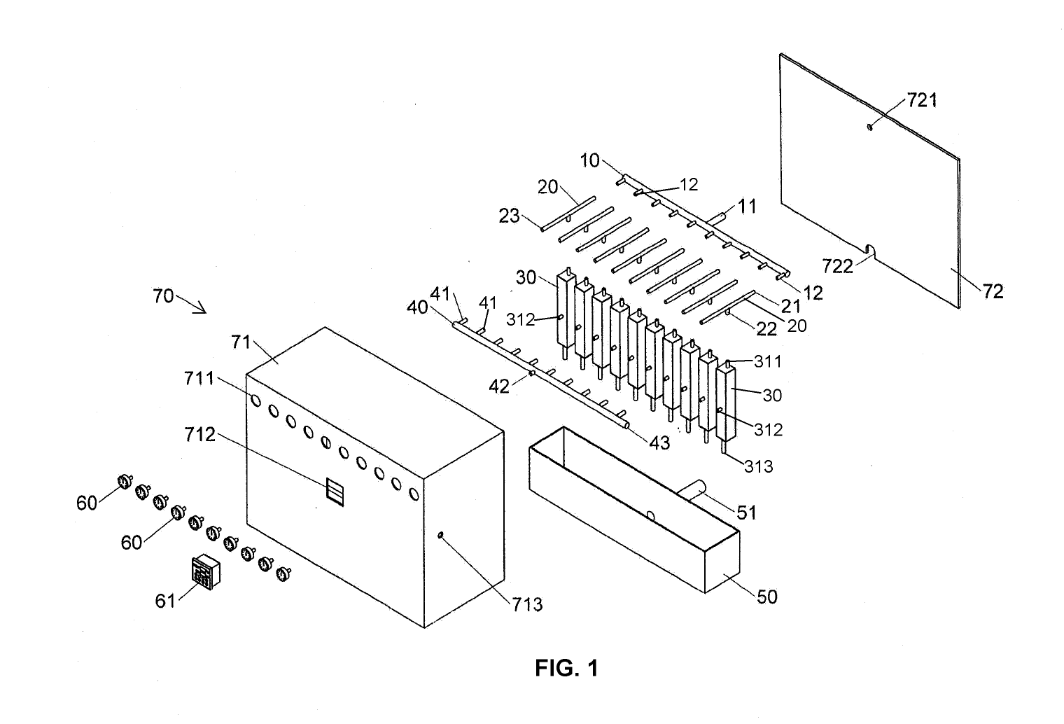

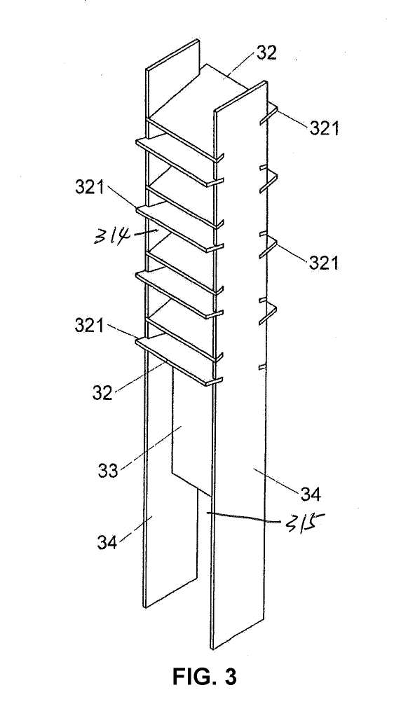

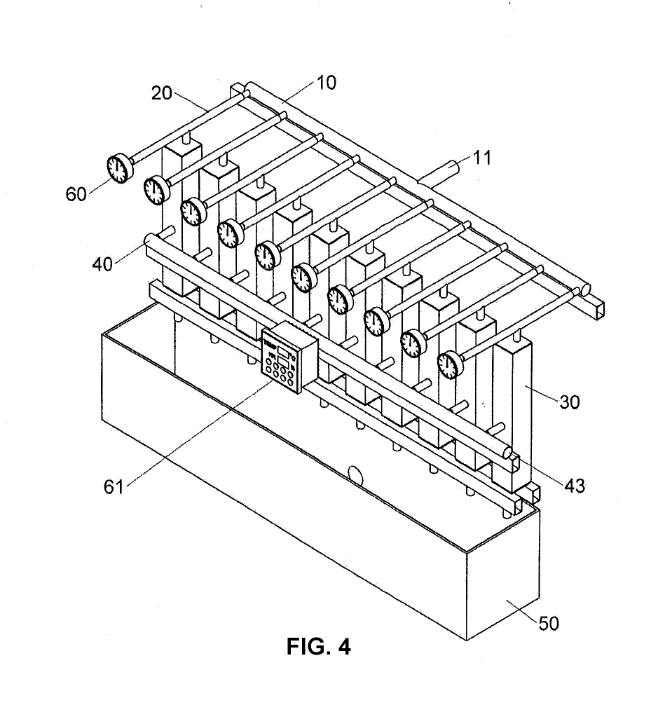

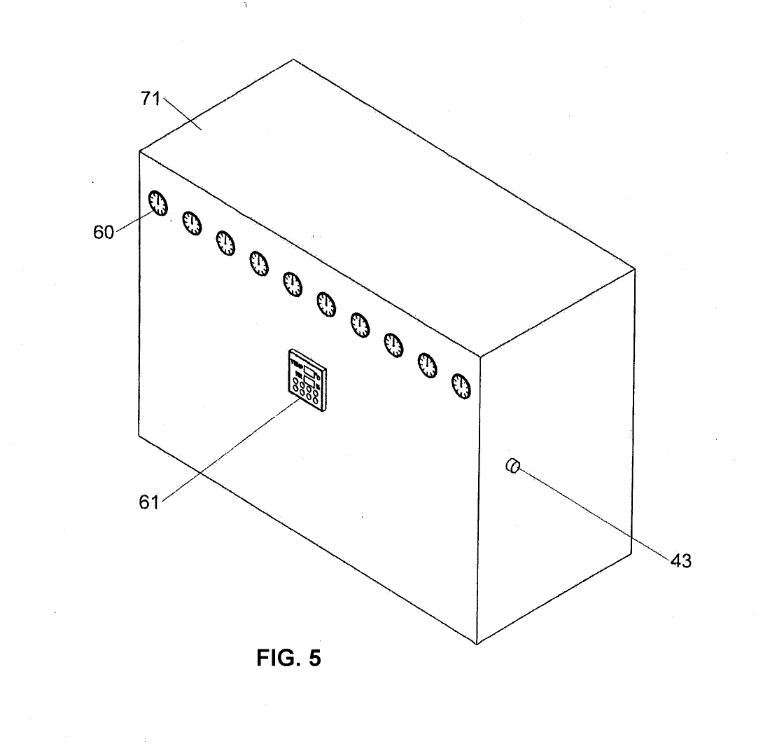

Referring to FIGS. 1 to 5, the dehydrating device of the present invention comprises an air diverging duct 10, at least a linkage tube 20, at least a dryer 30, an air converging duct 40, a water converging container 50 and a dehydrating room 70. Each part of the device is detailed as below:

the air diverging duct 10 including a first inlet 11 communicating with at least a first outlet 12; the first inlet 11 connecting with a blowing device which is an air compressor defined in one embodiment (not shown in the Figures); in a better embodiment of the present invention, the first inlet 11 of the air diverging duct 10 connecting with a thermohygrometer (not shown in the Figures) which measures and displays the temperature and the humidity of the air passing through the air diverging duct 10;

the linkage tube 20 including a second inlet 21, a second outlet 22 and a third outlet 23 communicating with each other; the second inlet 21 connecting with the first outlet 12 of the air diverging duct 10, and the third outlet 23 of the linkage tube 20 connecting with an air-flow meter 60 which measures the air amount in the linkage tube 20;

the dryer 30 including a housing 31, a plurality of separations 32 and a barricade 33; the housing 31 comprising a first chamber 310, a third inlet 311 communicating with the first chamber 310, a fourth outlet 312 and a drainpipe 313; the third inlet 311 connecting with the second outlet 22 of the linkage tube 20; the separations 32 dividing the upper portion of the first chamber 310 into a wavy first flow path 314, and the barricade 33 partitioning the lower portion of the first chamber 310 into a U-shape second flow path 315; the top of the first flow path 314 being adjacent to the third inlet 311 and its bottom being adjacent to the second flow path 315 whose manifold on the other side is adjacent to the fourth outlet 312; the drainpipe 313 locating at the lowest portion of the U-shape second flow path 315;

the air converging duct 40 including at least a fourth inlet 41, a fifth outlet 42 and a sixth outlet 43 communicating with each other; the fourth inlet 41 connecting with the fourth outlet 312 of the dryer 30, and fifth outlet 42 of the air converging duct 40 having a thermohygrometer 61 attached to measure the temperature and the humidity of the air passing through the air converging duct 40; in a better embodiment of the present invention, the fifth outlet 42 of the air converging duct 40 connecting with an air-flow meter (not shown in the Figures) which measures the air amount in the air converging duct 40;

the water converging container 50 receiving the water from the drainpipe 313 of the dryer 30, and one of its sides having a water outlet 51; and

the dehydrating room 70 allowing the air diverging duct 10, the linkage tube 20, the dryer 30, the air converging duct 40 and the water converging container 50 to be located within.

Referring to FIG. 1, in a better embodiment of the present invention, the quantity of the first outlet 12 is designed to be ten for the air diverging duct 10, and so are the quantity of the linkage tube 20 and the dryer 30. The quantity of the fourth inlet 41 is also designed to be ten for the air converging duct 40, and so is the quantity of the air-flow meter 60. Each second inlet 21 of the linkage tube 20 connects with a corresponding first outlet 12 of the air diverging duct 10, each fourth inlet 41 of the air converging duct 40 connects with a corresponding fourth outlet 312 of the dryer 30, and each air-flow meter 60 is installed at the distal end of a corresponding third outlet 23 of the linkage tube 20.

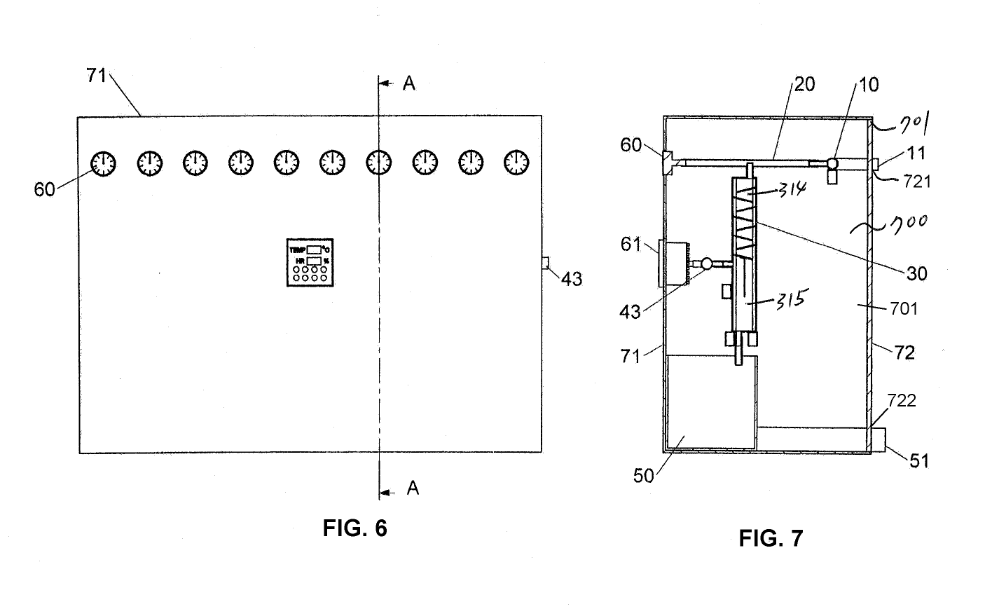

Referring to FIGS. 1 and 5 to 7, in a better embodiment of the present invention, the dehydrating room 70 comprises a box 71 and a box cover 72. An opening 701 is defined on the rear side of the box 71 and a second chamber 700 is concaved from the opening 701 towards the interior of the box 71. The opening 701 also covers the box cover 72. The air diverging duct 10, the linkage tube 20, the dryer 30, the air converging duct 40 and the water converging container 50 are all located within the second chamber 700 of the box 71. The box 71 has at least one meter hole 711 and one meter trough 712 defined on its front side for allocation of the air-flow meter 60 and the thermohygrometer 61 respectively.

Referring to FIG. 1, in a better embodiment of the present invention, a first hole 713 is defined on one sides of the box 71 for the fifth outlet 43 of the air converging duct 40 to pass through, a second hole 721 is defined on the box cover 72 for the first inlet 11 of the air diverging duct 10 to pass through, and a third hole 722 is defined at the bottom of the box cover 72 for the water outlet 51 of the water converging container 50 to pass through.

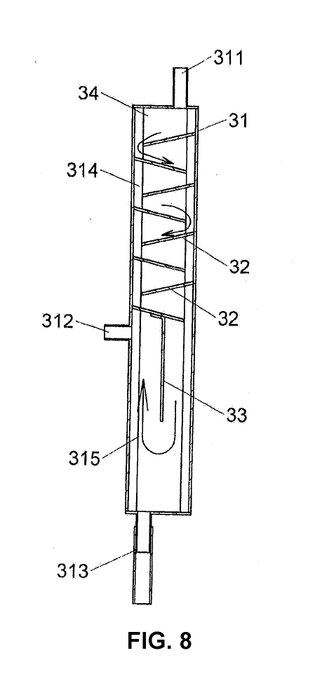

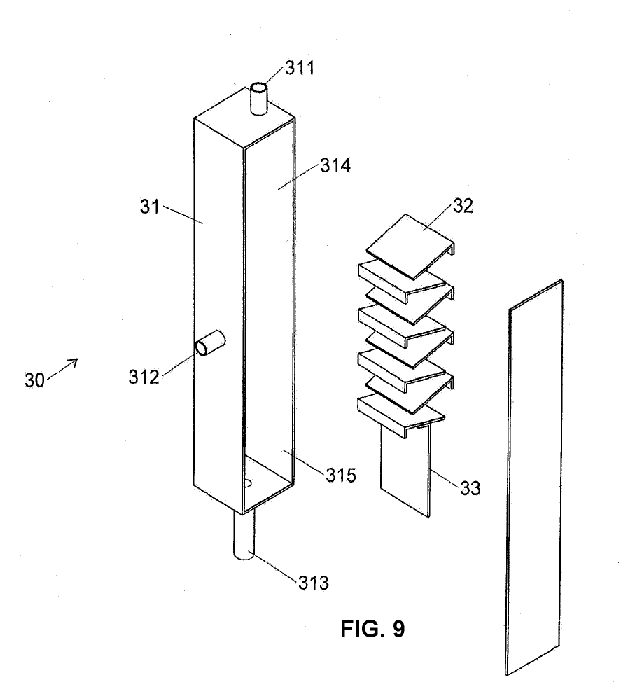

Referring to FIGS. 1 and 3 to 9, in an embodiment of the present invention, a plurality of separations 32 is orderly aligned from top to bottom. Every two adjacent separations 32 have opposite slopes in order to form a first flow path 314 in the first chamber 310, and an erective barricade 33 partitions the lower portion of the first chamber 310 into a U-shape second flow path 315. Inasmuch as each separation 32 is slanted with one end attached to the wall of the first chamber 310 and the other end distanced from the wall of the first chamber 310, the separations 32 all together are able to form a wavy first flow path 314 at the upper portion of the first chamber 310. The top end of the barricade 33 joins together with the lowest one of the separations 32, the bottom of the barricade 33 distances from the bottom of the first chamber 310, and the two sides of the barricade 33 attach to the sidewalls of the first chamber 310.

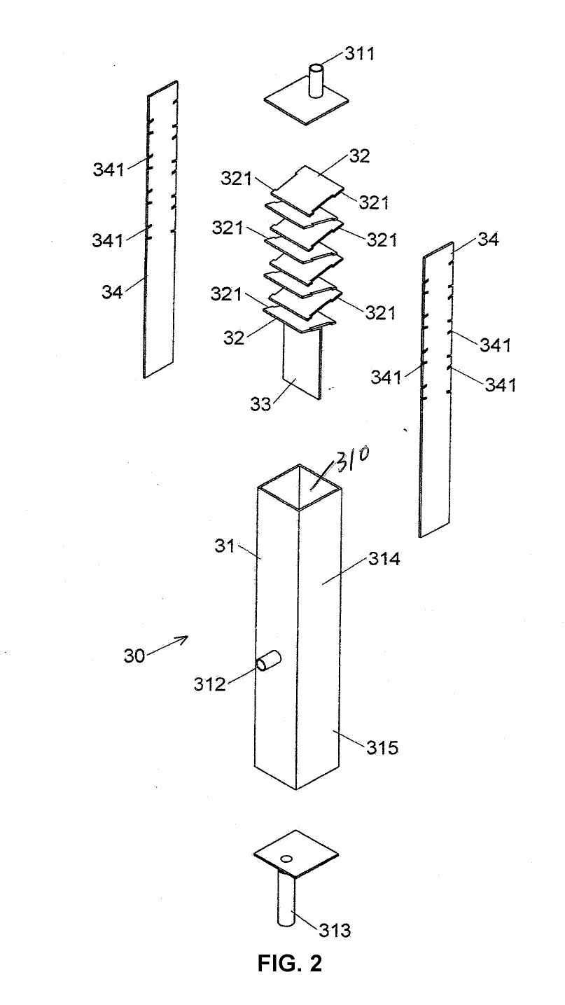

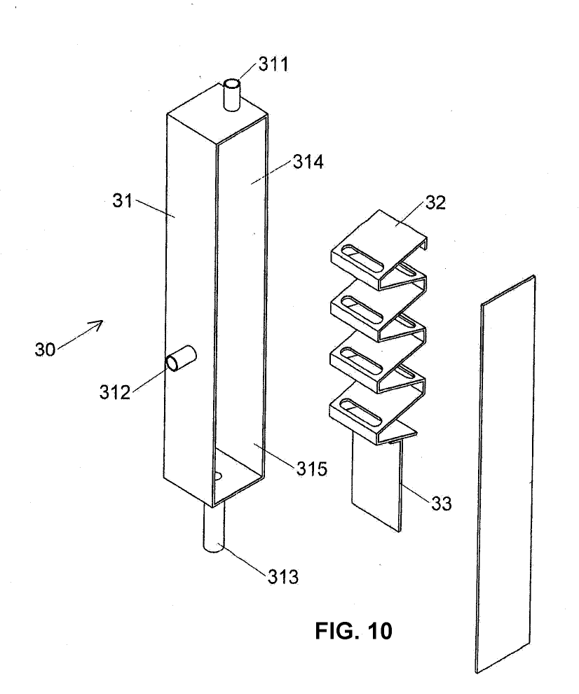

Referring to FIG. 2, in an embodiment of the present invention, two brace panels 34 are erected in parallel inside the first chamber 310. Each brace panel 34 has notches 341 defined on its both sides and each separation 32 has flanges 321 defined on its both sides. The notches 341 allow the flanges 321 to lodge in, so the separations 32 are able to be installed in the first chamber 310. Referring to FIG. 10, in a better embodiment of the present invention, every two adjacent separations 32 are partly joined to make all separations 32 connect together as one piece work.

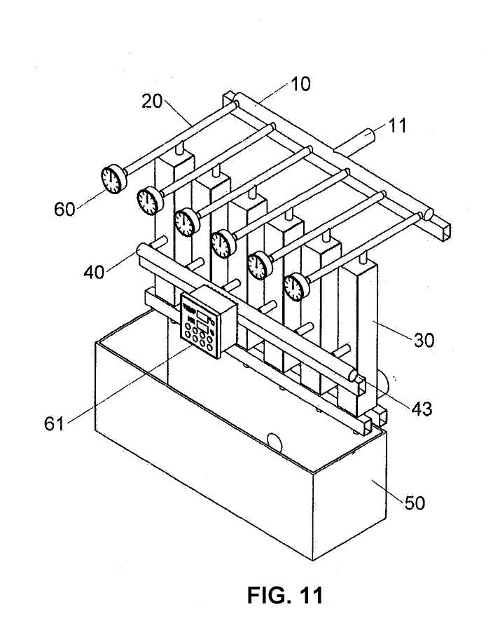

Referring to FIG. 1, in a better embodiment of the present invention, there is a plurality of linkage tubes 20. The air diverging duct 10 and the linkage tubes 20 are joined as one piece work. Referring to FIG. 11, in an embodiment of the present invention, the quantity of the dryer 30 is six.

Referring to FIGS. 1 and 6 to 8, after the dehydrating device is activated, the air blown from the blower sequentially passes through the first inlet 11 of the air diverging duct 10, the first outlet 12, the second outlet 22 of the linkage tube 20, the third inlet 311 of the dryer 30, the first flow path 314, the second flow path 315, the fourth outlet 312 and the fourth inlet 41 of the air converging duct 40 and then flows out of the sixth outlet 43 for further application. Wherein, after the air passes through the first flow path 314, the moisture of the air is going to deposit on the separations 32, flow downwards to the bottom of the first chamber 310 and then be drained out of the first chamber 310 through the drainpipe 313. The air reached the U-shape second flow path 315 has been dehydrated to certain level. When it flows out of the sixth outlet 43, the air is capable of being applied to dry other objects.

Advantages of the present invention are summarized as bellow.

1. The dryer equipped with the first flow path and the second flow path is able to improve the efficiency of air dehydration.

2. A plurality of dryers employed to dehydrate air is able to increase the amount of dry air.

3. Adopting laws of natural physics to dehydrate air is able to save energy.

4. Separations and the barricade employed to form the first flow path and the second flow path in the dryer are easy to be detached and cleaned.

5. The quantity of the dryer equipped in the device is flexible, depending on the amount of air required to be dehydrated.

While we have shown and described the embodiment in accordance with the present invention, it should be clear to those skilled in the art that further embodiments may be made without departing from the scope of the present invention.

What is claimed is:

1. A dehydrating device comprising:
an air diverging duct including a first inlet communicating with at least a first outlet and connecting with a blowing device;
at least a linkage tube including a second inlet communicating with a second outlet and connecting with the first outlet of the air diverging duct;
at least a dryer including a housing, a plurality of separations and a barricade; the housing comprising a first chamber, a third inlet communicating with the first chamber, a fourth outlet and a drainpipe; the third inlet connecting with the second outlet of the linkage tube; the separations dividing the upper portion of the first chamber into a wavy first flow path, and the barricade partitioning the lower portion of the first chamber into a U-shape second flow path; the top of the first flow path connecting with the third inlet and the bottom of the first flow path connecting with the second flow path whose manifold on one side connects with the fourth outlet; the drainpipe locating at the lowest portion of the U-shape second flow path;
an air converging duct including at least a fourth inlet communicating with a sixth outlet and connecting with the fourth outlet of the dryer;
a water converging container receiving the water from the drainpipe of the dryer and one of its sides having a water outlet; and
a dehydrating room allowing the air diverging duct, the linkage tube, the dryer, the air converging duct and the water converging container to be located within.

2. The dehydrating device as claimed in claim 1, wherein the linkage tube has an extra third outlet and the air converging duct has an extra fifth outlet; an air-flow meter, which measures the air amount in the linkage tube, is defined on the third outlet of the linkage tube; a thermohygrometer, which measures and displays the temperature and the humidity of the air passing through the air converging duct, is defined on the fifth outlet of the air converging duct; and the air-flow meter and the thermohygrometer are installed on the dehydrating room.

3. The dehydrating device as claimed in claim 2, wherein the dehydrating room comprises a box and a box cover; an opening is defined on the rear side of the box and a second chamber is concaved from the opening towards the interior of the box; the opening also covers the box cover; the air diverging duct, the linkage tube, the dryer, the air converging duct and the water converging container are all located within the second chamber; and the box has at least one meter hole and one meter trough defined on its front side for allocation of the air-flow meter and the thermohygrometer respectively.

4. The dehydrating device as claimed in claim 1, wherein the quantity of the first outlet is designed to be ten for the air diverging duct, and so are the quantity of the linkage tube and the dryer; the quantity of the fourth inlet is also designed to be ten for the air converging duct; each second inlet of the linkage tube connects with a corresponding first outlet of the air diverging duct; and each fourth inlet of the air converging duct connects with a corresponding fourth outlet of the dryer.

5. The dehydrating device as claimed in claim 1, wherein the dehydrating room comprises a box and a box cover; an opening is defined on the rear side of the box and a second chamber is concaved from the opening towards the interior of the box; the opening also covers the box cover; a first hole is defined on one sides of the box for the fifth outlet of the air converging duct to pass through; a second hole is defined on the box cover for the first inlet of the air diverging duct to pass through; and a third hole is defined at the bottom of the box cover for the water outlet of the water converging container to pass through.

6. The dehydrating device as claimed in claim 1, wherein a plurality of separations is orderly aligned from top to bottom; every two adjacent separations have opposite slopes in order to form a first flow path in the first chamber; and an erective barricade partitions the lower portion of the first chamber into a U-shape second flow path.

7. The dehydrating device as claimed in claim 1, wherein a plurality of separations is orderly aligned from top to bottom; every two adjacent separations have opposite slopes; each separation has two ends which one attaches to the wall of the first chamber and the other end distances from the wall of the first chamber, so the separations all together form a wavy first flow path; there is an erective barricade; and the top end of the barricade joins together with the lowest one of the separations, the bottom of the barricade distances from the bottom of the first chamber, and the two sides of the barricade attach to the sidewalls of the first chamber in order to partition the lower portion of the first chamber into a second flow path.

8. The dehydrating device as claimed in claim 7, wherein every two adjacent separations are partly joined to make all separations connect together as one piece work.

9. The dehydrating device as claimed in claim 1, wherein the first inlet of the air diverging duct connects with a thermohygrometer.

10. The dehydrating device as claimed in claim 1, wherein the fifth outlet of the air converging duct connects with an air-flow meter.

11. The dehydrating device as claimed in claim 1, wherein the blowing device is an air compressor.

12. The dehydrating device as claimed in claim 1, wherein there is a plurality of linkage tubes which are integrated with the air diverging duct as one piece work.
